(19) United States
(12) Patent Application Publication
(10) Pub. No.: US 2016/0227712 A1
(43) Pub. Date: Aug. 11, 2016

(54) Pyramidal Nursery Pot

(71) Applicants: Francisco Jose Perez-Vega, Cabo Rojo, PR (US); Josue Omar Perez-Del Valle, Cabo Rojo, PR (US)

(72) Inventors: Francisco Jose Perez-Vega, Cabo Rojo, PR (US); Josue Omar Perez-Del Valle, Cabo Rojo, PR (US)

(73) Assignees: Francisco Jose Perez-Vega, Cabo Rojo, PR (US); Josue Omar Perez-Del Valle, Cabo Rojo, PR (US)

(21) Appl. No.: 14/876,256

(22) Filed: Oct. 6, 2015

Related U.S. Application Data
(60) Provisional application No. 62/177,053, filed on Mar. 6, 2015.

(51) Int. Cl. A01G 9/02; A01G 9/10

(52) U.S. Cl. CPC A01G 9/026; A01G 9/1073

(57) ABSTRACT

A Pyramidal shaped nursery pot that provides improvement in pot stability against wind blow over, improves root development through air root pruning and grooves to guide the roots downward, and reduces weeding effort, without negatively impacting space utilization and water consumption. The pot is made of a semi-rigid, preferably biodegradable material, is delivered flat, and has a self closing mechanism to keep the sides joined when it is assembled. The pot has a plurality of triangular apertures cut on the vertical sides that fold outwards as a flange, with the objective of the opening created by these to facilitate drainage of excess liquid from the pot and the passage of air to the growing media to enhance root development through air-pruning, and the flange formed and folded outwards with an angle towards the inside of the pot to serve as a water capture mechanism when aerial irrigation occurs. The square bottom of the pot may be raised from the ground and has drainage holes, with the objective of facilitating drainage of excess liquid from the pot, and allowing air root pruning to avoid bottom roots from anchoring to the ground.

### BACKGROUND OF THE INVENTION

The present invention relates to the design of a Pyramidal plant growing, holding, transporting and planting container to be used in a nursery environment that provides better plant stability, improved root development and reduces growers weeding effort for plants with a single woody trunk or pseudo trunk.

The primary container for nursery production currently are pots made of Plastic High Density Polypropelene (HDPE) of cylindrical or conical shape. These pots are tapered from top to bottom (the top being wider than the bottom), primarily to facilitate plant extraction and to conform to the natural root development which typically is shaped like and inverted pyramid. Major drawbacks of these pots are: 1) the round shape of the pot guides the roots in spiral form (root circling), leading to future plant development and root anchoring problems, 2) storage and reuse difficult and costly and 3) losses due to instability of the pot when exposed to wind.

Weed control and prevention represents a high percentage of labor costs at nurseries. Gilliam et. al. 1990 estimated labor costs ranged from $246-$567/acre based on an average hourly wage of $3.53-$3.97. In 2004, North Carolina's annual weeding labor costs ranged from $967-$2,228/acre based on an hourly wage of $14.75/hr. The use of mulches to cover the top of the pot is a popular solution to weeding.

Instability of the current pots causes them to fall when exposed to wind resulting in loses of plants or fertilizer applications. This impact has been estimated to be from $0.12 to $1.63 per plant on industry studies. Newenhouse, et. al (2005) and Petersen (2014), summarized the container stabilization systems that exist on the market, some rely on stakes, others on rods that link pots together, others on trellises and baskets and others on insert systems where the container sits in a molded sleeve pot. They estimated that growers spend about 50 hours or $750 are spent a year lifting plants that fall. Parish, 2005, studied grower's labor and material costs for pot stabilization and concluded that the annual cost per tree for resetting it after it falls ranged from 12 cents to $1.63.

Some plant container patents have attempted improvements in pot stability and recognize the fact that a pot with a wider base than the top provides better stability and also recognize the fact that such shape requires the pot to be disassembled for transplanting. For example, Patent DE202007005294 U1, which proposes a foldable pot in the form of a truncated pyramid as well. However, it does not address improving root development through air-pruning, and uses additional elements, such as a rubber seal, security units and an intermediate floor to be assembled. This makes the pot more labor intensive to put together which is impractical for the nursery grower. This patent also proposes that the incremental sizes of the pot should have a top opening of a dimension that allows the prior size to be inserted through it when repotting, which causes the pot footprint to be different than the current trade sizes, thus limiting size and volume of the pots and potentially impacting space utilization at the nurseries. Patent WO1999001023A1 discloses a container made of plastic, brass, copper or stainless steel in the shape of a four-sided pyramid but designed for house plants with three sides fixed and one side openable with hinges or slidably to provide access to the plant when repotting is necessary. The pot is watered using a water receptable placed at the bottom so that the plant absorbs water through the bottom drain holes of the pot. Again, this pot design is not adequate for the nursery environment because of its cost and difficulty of storage and use. Patent WO1994026092A1 discloses a container for plants made of biodegradable material that has the upper opening with a larger horizontal cross sectional area than the cross sectional area of the base. Patent EP 1683410 A1, discloses a device for growing heavy bulky plants, that is of conical shape with the bottom wider that the top, that is assembled from two pieces an which has an accessory collar with a tripod to hold the plant trunk. Patent GB19320008617 discusses a pot with a tapering body that has a removable bottom used for germinating seeds and growing plants which at the time of planting, the bottom is removed to put the plant on the ground. Patent GB2315004A and GB399175A also disclose pots of conical shape with the bottom wider than the top. Patent U.S. 20140020288 A1 discloses a root ball container that has a conical shape for stability, constructed of plastic, metal or fabric. Patent U.S. Pat. No. 2,758,419 A discloses a plant container that is made of cardboard, of conical shape and that can be assembled through a fastening system. All these solutions are either too costly or difficult to assemble for them to be practical for the nursery grower.

Proper root and plant development is also influenced by pot design, since roots grow downwards and if they do not meet any physical obstruction, they may tend to grow laterally around the side of the container. Burden 1979, reported that spiral roots prevent the plant from becoming properly established in the surrounding soil, which can result in toppling, or even strangulation. Root spiraling is most serious in round, smooth-walled plastic containers as reported by Girouard (1982). To improve root development, Kinghorn (1974) recommended vertically oriented ribs or grooves about 2 mm (0.08 inch) high on the inner cavity wall of the pot that protrude into the growing medium and present an obstacle to spiral root growth intercepting spiraling roots and forcing then to grow downward to the drainage hole, where they stop growing because of the low humidity and become airpruned. Air-pruning of roots at the drainage hole is encouraged by providing a layer of air below the container. Armson and Sadreika (1979) reported that a 1.25-cm (0.5-inch) air gap beneath the container was most effective. Air root pruning is a well known method of improving root development. Attempts at providing a nursery pot with openings in the container walls for the purpose of promoting improved root development through air-prunning are disclosed in Patents U.S. Pat. No. 3,785,088, U.S. Pat. No. 5,241,784 A, U.S. Pat. No. 795427, U.S. Pat. No. 7,210,266B2, U.S. Pat. No. 4,497,132A, U.S. Pat. No. 4,939,865, U.S. Pat. No. 4,753,037 A, U.S. Pat. No. 4,442,628 A and U.S. Pat. No. 5,099,607A. However, these patents do not address changes in the pot design to improve its stability. Patent U.S. Pat. No. 5,054,235A discusses a conical pot of multiple intersecting walls that guide the roots and avoid roots circling.

The current invention provides the necessary features to improve root development, provide better pot stability for single trunk plants and trees and minimize weeding effort.

### BRIEF SUMMARY OF THE INVENTION

Accordingly, it is an object of the present invention, namely, the Pyramidal Nursery Pot, to provide a pot and a method for employing it in the nursery to totally avoid the above mentioned and other disadvantages that Nursery Growers face with the traditional cylindrical pots, in particular, root circling, excessive weeding effort and pot instability.

It is a more particular object of the present invention to enhance root and plant development by the incorporation of holes placed strategically in the pot to stimulate air root pruning.

It is a further object to cover woody plants in the full range of the growing cycle from trade nursery pot sizes of 4″ to 45 gallons.

It is a further object of the present invention to not impact water consumption at the nursery by providing the design with a water capture mechanism when aerial irrigation is used.

It is a further object of the present invention to not impact current space utilization in the nursery by making the amount of horizontal space required by each size of the pot, equivalent to that of the current pots in use.

It is a further object of the present invention to minimize the costs of transportation and storage prior to use, by providing a pot design that is delivered flat, thus, reducing the amount of space required to pack it, store it and facilitate its reuse.

It is a further object of the present invention to not impact or reduce the amount of growing media required by each pot size to produce a plant of the same size and development as the current nursery pots in use.

These and other related objects are achieved according to the present invention and are not bounded by the material used to build the pot, as long as it is formed of a semi-rigid, preferably biodegradable material capable of being manufactured at a low cost, which is resistant both to the growing media or mixture, humidity, UV exposure and the liquid or granular chemicals regularly applied to the media. The benefits are inherent to the shape and design itself, regardless of the material.

The present invention is unique in that in a single piece design the following is achieved:
1. improved stability because of the lower center of gravity of the pot,
2. improved root development through air root pruning,
3. does not impact water consumption and allows the pot to be used for both drip and aerial irrigation because of the design of the cutout flanges folded out with an angle towards the inside on the side walls of the pyramid that help capture water,
4. maintains the top of the pot at a minimal size, hence, reducing weeding effort required,
5. maintains nursery floor space utilization equal to today's pot trade sizes space requirements,
6. potentially reduces storage space requirements since the pot is delivered flat and when disassembled, can be stored flat until reused.

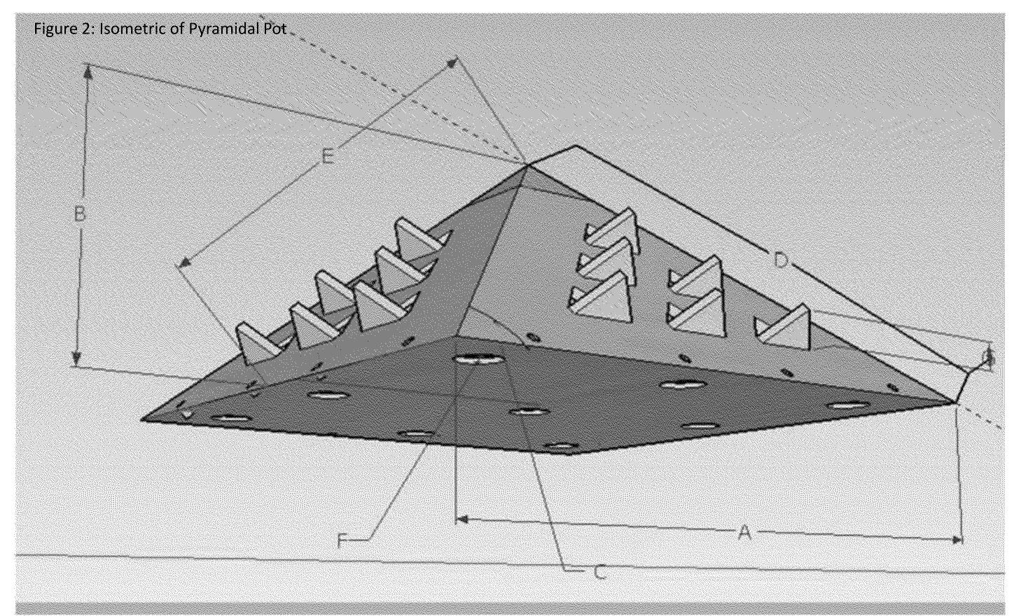

FIG. 2 illustrates the pot dimensions for cross reference with Table1 and Table 2.

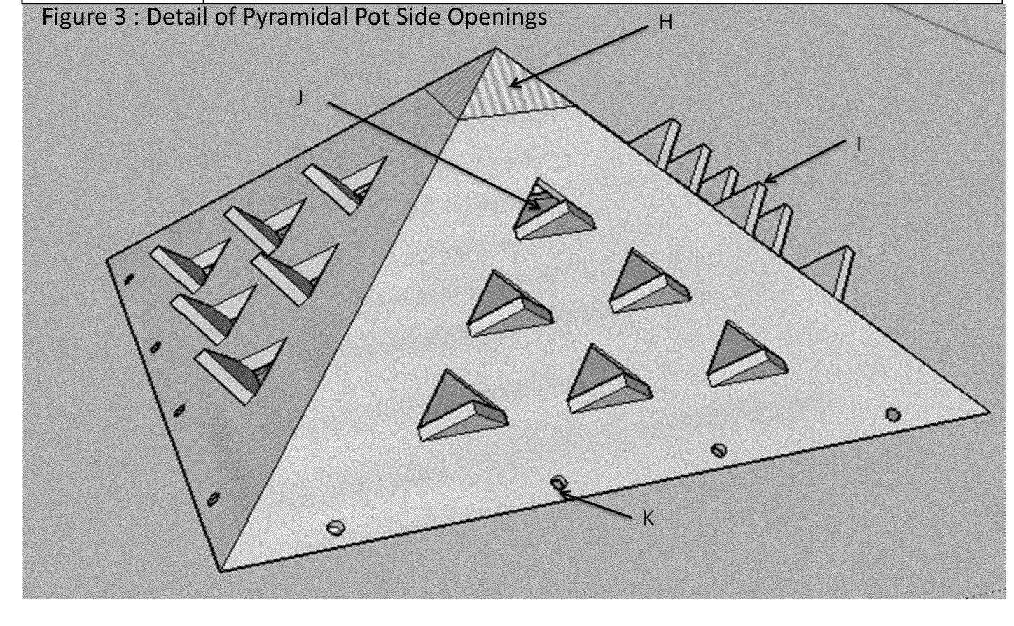

FIG. 3 illustrates the pot with the top modified to form fringes that capture water.

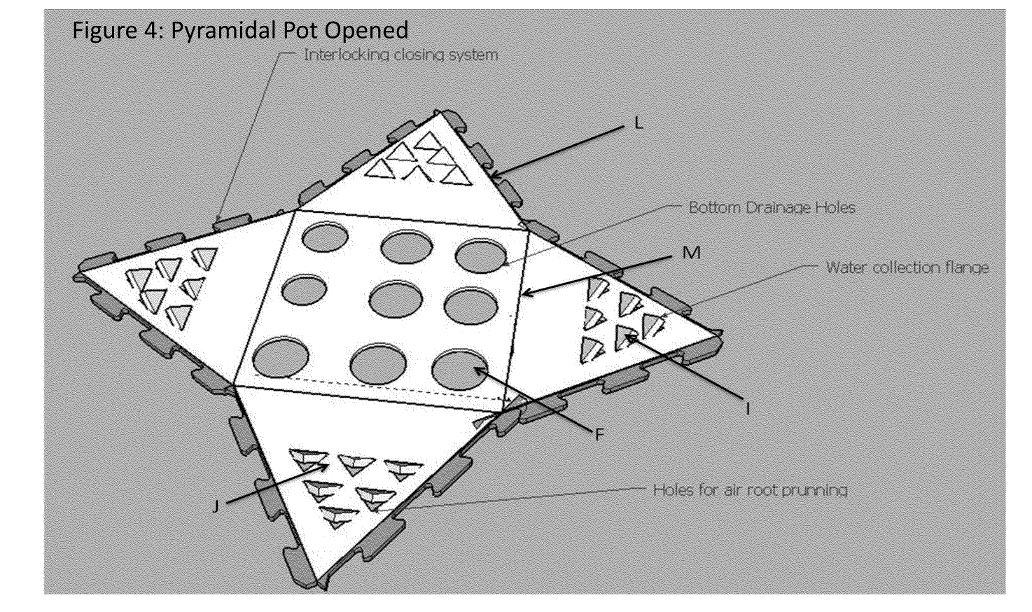

FIG. 4 illustrates the pot as it would be delivered to a nursery flat. This would be the configuration used for shipping and for storage prior to use or reuse.

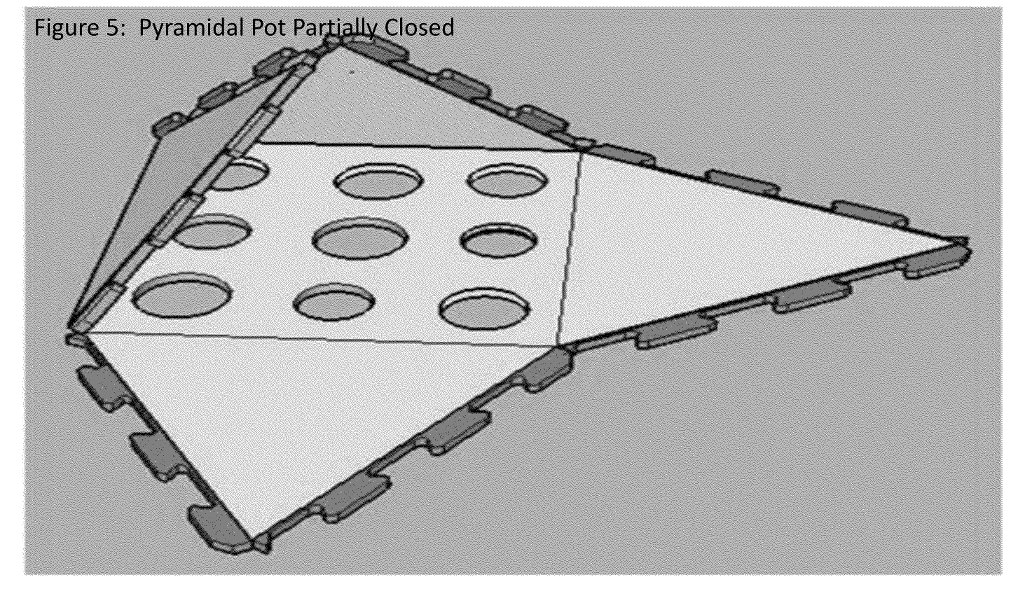

FIG. 5 illustrates the pot with two sides folded as when it is ready to receive the growing medium and plant.

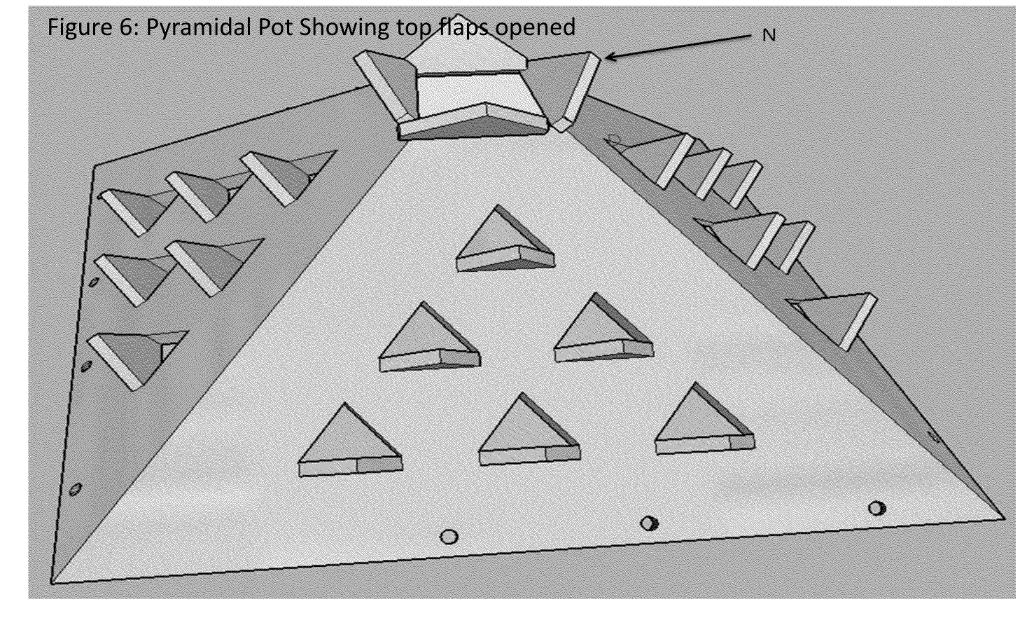

FIG. 6 illustrates an embodiment with modified top to allow more water capture and/or access for granular fertilization.

### DETAILED DESCRIPTION OF THE INVENTION

Before the present Pyramidal plant container and methods are disclosed and described, it is to be understood that this invention is not limited to the particular configurations, process steps, and materials disclosed herein as such configurations, process steps, and materials may vary somewhat. It is also to be understood that the terminology employed herein is used for the purpose of describing particular embodiments only and is not intended to be limiting since the scope of the present invention will be limited only by the appended claims and equivalents thereof.

It must be noted that, as used in this specification and the appended claims, the singular forms “a,” “an,” and “the” include plural referents unless the context clearly dictates otherwise. Thus, for example, reference to “a plant” includes two or more plants, reference to “a biodegradable material” includes reference to a mixture of two or more biodegradable materials, and reference to “growing media” includes reference to a mixture of two or more plant growth media.

Unless defined otherwise, all technical and scientific terms used herein have the same meanings as commonly understood by one of ordinary skill in the art to which this invention belongs.

As used herein, “plant” includes a propagule thereof. Thus, reference to a plant container according to the present invention for receiving “a plant” includes reference to a seed, a spore, a cutting, and any other part of the vegetative body capable of independent growth if detached from the parent.

When considering pot shapes, a pot with a broader base than the top is ideal for stability because having the base broad makes the pot less prone to “blow-over” given the lower center of gravity. Also, having the top small helps reduce the surface area exposed where weeds will develop. However, such shape precludes plant removal from the pot at the time of transplant, is counter to the desired root system shape that is an inverted pyramid and might impact aerial irrigation effectiveness. The pyramidal shape provides these characteristics and the above mentioned drawbacks as well.

However, the pyramidal shape is ideal in terms of stability and weed prevention, is suitable for drip irrigation applications and for plants or trees that are single trunk. But, needing the feature of air root pruning and efficient water usage on the pot, the current invention devises a set of triangular flanges on the wall of the pot that would serve as air holes for root pruning, for drainage and also for water capture during aerial irrigation. Air pruning on the bottom of the pot, is achieved through a set of drainage holes on the bottom and by having the bottom raised 1.25 cm (0.5 inches) to allow an air pocket below the pot that would help air prune roots reaching the bottom of the pot, thus avoiding undesired root anchoring.

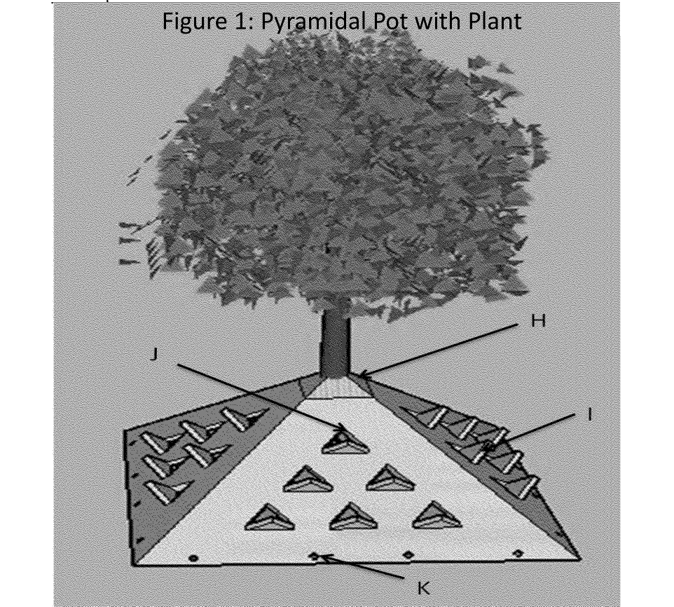

FIG. 1. shows an embodiment the pot design. The pot consists of a square pyramid with sides that are notched so that when each side is folded, the notches (L) cross and hold the sides closed. Note that there are bottom drainage holes (F) and the bottom may be raised preferably 1.25 cm (0.5 inches) to allow air to pass below the pot. Each side of the pyramid has a plurality of inverted “V” shaped notches (I) that when folded serve to capture water going down the pyramid wall, and the hole on each notch (J) serves for air root pruning. Depending on the plant to be potted, these notches (I) can be adjusted to be more open or more closed to adjust the amount of water that enters the pot from aerial irrigation.

The pot is formed of a semi-rigid, preferably biodegradable material capable of being manufactured at a low cost, that can withstand ultraviolet light exposure, is resistant to the growing media or soil and the liquid nutrients and chemicals periodically applied at the nursery, and must be durable for a reasonable amount of time in nursery environment conditions. The pot is to be preferably molded or routed with techniques such as CNC, and should be understood by those skilled in molding/routing art, that the ribs, grooves, and ridges can be formed during the molding/forming process.

The plurality of drainage holes (F & K), notches or flanges (I) can be done by a punch press or router process. Although the notches or flanges shown are triangular, it will be understood that other shaped openings could be as well provided, as long as they serve the same purpose of providing drainage, water capture and root air pruning. The shape, size and number of the holes and notches may be varied depending on the size of the pot to be built and on the circumstances or plants for which the pot will be made.

The pyramidal container of the present invention can be used for growing plants closing two sides of the pyramid, placing between ½ to % of the volume required of a selected plant growth medium, such as soil or potting mix, into the pot and then placing one or more seeds or other propagules in the plant growth medium. Similarly, a seedling may be transplanted or a cutting may be rooted in the plant growth medium. Then the additional volume of growing media is added and the other two sides are closed. The plant can be exposed to selected environmental conditions of temperature, moisture, and light to permit the plants to grow. At a time when the plant is ready for transplant, the pot is opened and the plant removed from the pot and planted in a larger pot, in a field, landscape, flowerbed, or other selected location. Another scenario, depending on the material chosen for the pot, especially if the material is biodegradable, is that the pot and the plant it contains can be planted as a unit in a landscape, field, flowerbed, larger pot, or other selected location.

Due to the features incorporated in the present invention, vigorous root development has been observed on tests in the nursery environment. The openings on the pyramid wall and the bottom and the square profile of the pot with the internal grooves guide the roots downward. Also, field and lab tests demonstrated that the current pot is significantly more stable (44% more) than the current cylindrical nursery pots and reduce weeding effort by at least 42%.

Based on this, the objects of the present invention have been fulfilled.

FIG. 3 shows an embodiment that has the top modified as fringes (H) that help to cover the area between the trunk and the edges of the pyramid to prevent weeds growth.

FIG. 4 shows one embodiment of the pot self latching borders (L) and the pot in its flat position. Another possible embodiment of the present invention, might have an alternate closing mechanism consisting of circular protuberances that enter into opposite holes that when snapped close together. Another possible closing mechanism consists of a piece of string that can be tied from circular buttons on each of the tips of pyramid sides (similar to button and string envelopes closing mechanism). Other closing methods may be employed as long as they do not add substantial additional cost and labor.

FIG. 5 shows an embodiment of the pot partially closed as when it is being prepared to put the growing medium in it.

Table 1. Shows potential variations of the pot dimensions (refer to FIG. 2 for reference to dimensions) as it is scaled to different nursery typical pot sizes, when the objective is to have each pot size utilize the same amount of space as current nursery pots use and save on growing media.

FIG. 6 shows another embodiment of present invention where the top of each side of the pyramid is modified to be foldable allowing it to capture more aerial irrigation water or to allow access for granular fertilization. This may be useful for times when more water is required because the plant propagule requires more water.

TABLE 1
Pot dimensions to provide savings in growing media and equivalent space utilization as current trade nursery pots.
Pot Dimensions and Internal volume
Equivalent space (base)

| | Drawing reference | | | | | | | | | | |
|---|---|---|---|---|---|---|---|---|---|---|---|
| | Pyramidal Pot | | | | | | | | | | |
| | | | | | | Number | F | | G | | |
| | | | | | | of | Size of | Number | Size of | | |
| | | | C | D | E | bottom | bottom | of V | the V | | |
| | A | B | Dihedral | Slant | Slant | drainage | drainage | shaped | shaped | Volume | Volume |
| Trade size | Base | Height | Angle | edge | height | holes | holes | flanges | flanges | (cm3) | (lts) |

| | | | | | | | |
|---|---|---|---|---|---|---|---|
| 4″ | 9.9 | 7.8 | 57.6 | 10.5 | 9.24 | 254.8 | 0.3 |
| 5″ | 12.5 | 9.4 | 56.4 | 12.9 | 11.3 | 489.6 | 0.5 |
| 6″ | 14.5 | 11.5 | 57.8 | 15.4 | 13.6 | 806.0 | 0.8 |
| 8″ | 20 | 14.6 | 55.6 | 20.3 | 17.7 | 1946.7 | 1.9 |
| 1 Gal | 17 | 15 | 60.5 | 19.2 | 17.2 | 1445.0 | 1.4 |
| 1.5 Gal | 23 | 21.5 | 61.9 | 27 | 24.4 | 3791.2 | 3.8 |
| 2 Gal | 23.5 | 23 | 62.9 | 23.4 | 25.8 | 4233.9 | 4.2 |
| 2.5 Gal | 26 | 23 | 60.5 | 29.4 | 26.4 | 5182.7 | 5.2 |
| 3 Gal | 27 | 24 | 60.6 | 30.7 | 27.5 | 5832.0 | 5.8 |
| 5 Gal | 33 | 29 | 60.4 | 37.2 | 33.4 | 10527.0 | 10.5 |
| 7 Gal | 38 | 30 | 57.7 | 40.3 | 35.5 | 14440.0 | 14.4 |
| 10 Gal | 40 | 38 | 62.2 | 47.4 | 42.9 | 20266.7 | 20.3 |
| 15 Gal | 38.5 | 47 | 67.7 | 54.3 | 50.8 | 23221.9 | 28.2 |
| 20 Gal | 62 | 44 | 54.8 | 62.1 | 53.8 | 56378.7 | 56.4 |
| 45 Gal | 77 | 52.5 | 53.7 | 75.6 | 65.1 | 103757.5 | 103.8 |

Table 2. Shows potential variations of the pot dimensions as it is scaled to different nursery typical pot sizes, when the objective is to have each pot size utilize the same amount of space as current nursery pots use while maintaining the same amount of growing media for each pot size.

### PATENT CITATIONS

| Cited Patent | Filling date | Publication date | Applicant | Title |
|---|---|---|---|---|
| U.S. Pat. No. 3,785,088 A | 26 Feb. 1973 | 15 Jan. 1974 | Guarriello, T. | Nursery Pot |
| DE202007005294U1 | 12 Apr. 2007 | 27 Dec. 2007 | Bipplinger, W. | Plant Pot Foldable in the form of a Pyramid |
| WO 1999001023A1 | 30 Jun. 1998 | 14 Jan. 1999 | Geary, T. M. | Plant container |
| U.S. Pat. No. 5,241,784A | 10 Aug. 1992 | 7 Sep. 1993 | Henry, E. I. | Plant root container and method of air root |
| | | | | pruning |
| U.S. Pat. No. 7,210,266B2 | 21 Apr. 2005 | 1 May 2007 | Henry, I. H | Plant root pruning container |
| GB399175A | Not available | Not available | Billinghurst, P. | Title not available |
| U.S. Pat. No. 4,497,132 A | 9 Nov. 1981 | 5 Feb. 1985 | Whitcomb, C. E. | To contain a growing medium and a plant |
| US20140020288 | 12 Mar. 2013 | 23 Jan. 2014 | Sikes, G. | Root ball container |
| U.S. Pat. No. 5,054,235A | 24 Aug. 1990 | 8 Oct. 1991 | Pliz, D. | Nursery Plant Containers |
| U.S. Pat. No. 2,758,149A | 17 Dec. 1952 | 14 Aug. 1956 | Schmitz, J. F. | Plant Container |
| WO9426092A1 | 13 May 1994 | 24 Nov. 1994 | Davis, G. | Container for plants |
| GB2315004A | Not available | Not available | William, R. | Title not available |

TABLE 2
Pot dimensions to provide equivalent space utilization and equivalent soil volume as current trade nursery pots.

| | Drawing reference | | | | | | | | | |
|---|---|---|---|---|---|---|---|---|---|---|
| | Pyramidal Pot | | | | | | | | | |
| | | | | | | | F | | | |
| | | | | D | E | Size of | Number | Size of | | |
| | | | C | Slant | Slant | bottom | of V | the V | G | |
| | A | B | Dihedral | edge | height | drainage | shaped | shaped | Volume | Volume |
| Trade size | Base (cm) | Height (cm) | Angle | (cm) | (cm) | holes | flanges | flanges | (cm3) | (lts) |

| | | | | | | | |
|---|---|---|---|---|---|---|---|
| 4″ | 9.9 | 13.2 | 69.5 | 15 | 14 | 432.0 | 0.4 |
| 5″ | 12.5 | 16.9 | 69.7 | 19.1 | 18 | 879.6 | 0.9 |
| 6″ | 14.5 | 20.3 | 70.4 | 22.8 | 21.6 | 1423.3 | 1.4 |
| 8″ | 20 | 25.8 | 68.8 | 29.4 | 27.7 | 3440.9 | 3.4 |
| 1 Gal | 17 | 26.8 | 72.4 | 29.4 | 28.1 | 2582.9 | 2.6 |
| 1.5 Gal | 23 | 40.4 | 74.1 | 43.6 | 42 | 7131.3 | 7.1 |
| 2 Gal | 23.5 | 44.5 | 75.2 | 47.5 | 46 | 8187.3 | 8.2 |
| 2.5 Gal | 26 | 45.4 | 74 | 48.9 | 47.2 | 10219.5 | 10.2 |
| 3 Gal | 27 | 48.6 | 74.5 | 52.2 | 50.4 | 11805.8 | 11.8 |
| 5 Gal | 33 | 53.1 | 72.7 | 58 | 53.6 | 19276.0 | 19.3 |
| 7 Gal | 38 | 56.8 | 71.5 | 62.9 | 59.9 | 27362.5 | 27.4 |
| 10 Gal | 40 | 78.8 | 75.8 | 83.7 | 81.3 | 42030.7 | 42.0 |
| 15 Gal | 38.5 | 109 | 80 | 113 | 111 | 54006.2 | 54.0 |
| 20 Gal | 62 | 82 | 69.3 | 93 | 87.7 | 105097.8 | 105.1 |
| 45 Gal | 77 | 98.4 | 68.6 | 112 | 106 | 194464.7 | 194.5 |

Having disclosed the preferred embodiments, it is manifest that details of construction, fabrication, material, assembly and use can be changed without departing from the scope and spirit of the present invention. The present embodiments are for exemplification and are to be considered in all respects as illustrative and not restrictive. The scope of the invention is established by the claims made rather than by the description provided. This includes the full range of equivalents to which each element is entitled.

What is claimed is:

1) A nursery pot shaped as a pyramid that will contain a growing media and a plant or plants to be grown in such media, comprising of flat material that when folded forms the shape of the pyramid and has self-closing mechanism to join the sides and keep them together. Such closing mechanism can be reopened at the time of plant transplant and allows the pot to be reused if so desired.

2) The nursery pot of claim 1 with each triangular side having a plurality of triangular or equivalent apertures cut on the two vertical sides that fold outwards as a flange, with the objective of the opening created by these to facilitate drainage of excess liquid from the pot and the passage of air to the growing media to enhance root development through air-pruning, and the flange formed and folded outwards with an angle towards the inside of the pot to serve as a water capture mechanism when aerial irrigation occurs.

3) The nursery pot of claim 2 further including the square bottom of the pot raised at a minimum of 1.25 cm (0.5 inches) from the ground and having at least 5 drainage holes, with the objective of facilitating drainage of excess liquid from the pot, and allowing air root pruning to avoid bottom roots from anchoring to the ground.

4) The nursery pot of claim 3 further including internal wall ridges or flanges that serve to guide the roots downward avoiding root circling.

5) The nursery pot of claim 4 wherein the said pot is formed of semi rigid material, of any of the following potential materials but not limited to these: any type of plastic (not preferred), bioplastic, Shrilk (processed shrimp shells that make a plastic like product), Pressed fiber Geotextiles, Impermeable paper from biotechnological treatment of paper sludge or using nanotechnological processes, plastic made from Chicken feather's keratin, Prodegradant concentrates, Liquid woods, Aliphatic polyesters, Starch-based Polymers and molding out of scrap vegetative products (rice hulls, coir, peat moss).

6) The nursery pot of claim 5 scaled as per the dimensions listed in Table 1, if the objective is to use equivalent space as current nursery trade pots demand, and at the same time have savings in growing media.

7) The nursery pot of claim 5 scaled as per the dimensions listed in Table 2, if the objective is to use equivalent space as current nursery pots demand, but also maintain the same volume of growing media per pot size.

8) The nursery pot of claim 5 scaled at any other dimensions deemed necessary.

9) The nursery pot of claims 6 and 7 with an internal reinforcement flange centered internally on each side of the pyramid to provide more support to the trunk of the plant so that it stays straight and perpendicular to the bottom of the pot.

10) The nursery pot of claims 6 and 7 with a rod running from the bottom of the pot upwards towards the center of the pyramid with the purpose of having the plant trunk tied to the rod in order to keep it straight during growth.

11) The nursery pot of claims 6 and 7 with the top of each side of the pyramid modified as illustrated in FIG. 6 to serve as a water capture mechanism or allow access for granular fertilization.
